(19) United States
(12) Patent Application Publication
(10) Pub. No.: US 2026/0014605 A1
(43) Pub. Date: Jan. 15, 2026

(54) DESICCATOR

(71) Applicants: DONGHONG SUN, OCEANSIDE, CA (US); DANIEL YUNLONG SUN, CHINO, CA (US)

(72) Inventors: YONGLAO LIU, Zhengzhou (CN); XIAODONG SUN, Zhengzhou (CN); YONG DENG, Panmen (CN)

(21) Appl. No.: 18/772,610

(22) Filed: Jul. 15, 2024

(51) Int. Cl. B09B 3/40; B09B 3/35; B09B 101/70

(52) U.S. Cl. CPC B09B 3/40; B09B 3/35; B09B 2101/70

(57) ABSTRACT

A desiccator has a grinder. The grinder is configured to receive intake material. A grinder outlet tube connects the grinder to the desiccator assembly. A desiccator assembly is configured to desiccate the intake material. The grinder outlet tube is configured to transfer the intake material from the grinder to the desiccator chamber. An electronic controller controls the operation of the grinder and the desiccator assembly. The grinding blade is mounted above a grinding blade table. The grinding blade is mounted in a grinding chamber of the grinder. The grinding blade is configured to grind the intake material to a small enough size to pass through the grinder outlet tube. The desiccator assembly further includes a desiccator drum rotatably mounted on a drum.

### TECHNICAL FIELD

The present invention is in the field of desiccators.

### BACKGROUND

Traditionally, a variety of garbage disposers have been discussed in United States patents. For example, in China patent number 212884107 entitled “Energy-saving environment-friendly kitchen garbage disposer” by Xu Jingbin, published April 4, 2021, the inventors describe, "The utility model relates to an energy-saving and environment-friendly kitchen garbage disposer, which comprises an outer shell, wherein the side wall of the outer shell is provided with a feed inlet, a roller, an electromagnetic device and a forward and reverse rotating motor are arranged in the outer shell, the roller can be rotatably arranged at the upper part of the outer shell, a nozzle is aligned with the feed inlet, the inner wall of the roller is provided with a guide plate, the guide plate is obliquely extended from the left end to the right end of the roller, the forward and reverse rotating motor drives the roller to rotate through chain connection, and the electromagnetic device is; the shell body is provided with a control device, and the control device comprises a controller and a temperature control system. The utility model discloses a kitchen garbage processor adopts drum-type pasteurization drying process, turns into fertilizer or fuel with rubbish from cooking, turns into fertilizer or fuel completely, need not to wash the emission, practices thrift domestic water, and dry back rubbish is stored in the storage case, and the stink that the wet rubbish that significantly reduces sent keeps the kitchen interior air fresh, satisfies people to the environmental requirement in kitchen.”

For example, in China patent number 210887463 entitled “Grinding device for kitchen waste treatment” by Xu Jingbin Deng Yong, published June 30, 2020, the inventor describes “The utility model relates to a grinding device for kitchen garbage disposal, which comprises a grinding cylinder, a grinding pool, a grinding disc and a driving motor, wherein the grinding pool is fixedly assembled at the bottom of the grinding cylinder, the object to be ground is placed in the grinding cylinder, the grinding disc is assembled in the grinding pool, the driving motor drives the grinding disc to make high-speed fixed-axis rotary motion, and the grinding disc is matched with the inner peripheral wall of the grinding pool to grind the object to be ground; the upper surface of the grinding disc is fixedly provided with a hook column, the top end of the hook column is provided with a cutting part, the cutting part and the hook column are distributed in an L shape, and the cutting part is arranged towards the rotation direction of the grinding disc. The utility model discloses a configuration of grinding device through the hook post makes its preliminary treatment that can smash the great rubbish of volume for kitchen garbage gets into more easily and carries out the grinding processing in the mill pond, thereby makes the kitchen garbage kind that this grinding device handled more, and the volume is bigger, reduces the operation of cutting up in advance to rubbish, and it is more convenient to use, and kitchen garbage's grinding efficiency also effectively promotes.”

For example, in China patent number 102284332 entitled “Grinding device for kitchen waste treatment” by Xu Wei, published December 21, 2011, the inventor describes, “The invention discloses a food waste disposer, which comprises a shell, an upper crushing chamber, a lower crushing chamber, a cutter disk component and a motor component, wherein the upper crushing chamber for holding food waste is formed on the upper part of the shell; the lower crushing chamber is formed below the bottom of the upper crushing chamber; an upper grinding ring is arranged in the upper crushing chamber; the cutter disk component is arranged in the lower crushing chamber; the motor component for driving the cutter disk component to rotate is arranged on the lower part of the shell; and a lower grinding ring is arranged in the lower crushing chamber. In the disposer, a coaxial connecting annular surface is formed between the upper grinding ring and the lower grinding ring; and a certain amount of food wastes, particularly fiber type food wastes, can be gathered by the structure. In addition, since the upper grinding ring is provided with grinding grooves and transverse bumps which are arranged in a staggering mode, the grinding fineness and the grinding speed of foods can be effectively improved, bone type food wastes can be prevented from impacting the upper crushing chamber, and the life of the upper crushing chamber can be prolonged; and the food waste disposer is convenient to assemble and has superior performance.”

For example, in China patent number 102941146 entitled “360-degree combing assembly of waste processor” by Zhang Jianming, published February 27, 2013, the inventor describes, “The invention relates to a 360-degree combing assembly of a waste processor. The 360-degree combing assembly comprises a filtering chassis and a stirring paddle, wherein the filtering chassis is fixedly arranged in the waste processor; the stirring paddle is rotatably arranged above the filtering chassis; a plurality of filtering holes are formed in the surface of the filtering chassis; lower comb teeth are arranged on the top surface of the filtering chassis in the radial direction; upper comb teeth are arranged on the bottom surface of the stirring paddle; and the upper comb teeth and the lower comb teeth are staggered. According to the waste processor, through the stagger cooperation of the lower comb teeth of the filtering chassis and the upper comb teeth of the stirring paddle, when the stirring paddle rotates, the upper comb teeth pass through the tooth spaces of the lower comb teeth and can shear, so that relatively large food waste which can not pass through the tooth spaces can be cut off by the shearing force so as to be broken via repeating for a plurality of times, so that the waste treatment is relatively environment-friendly and a pipeline is prevented from being blocked.”

For example, in China patent number 111266385 entitled “Automatic domestic waste treatment device” by Yang Minjie, published June 12, 2020, the inventor describes, “An automatic household garbage disposal device comprises a primary classification receiving device, a classification garbage channel, a primary disposal device and a chip disposal device, wherein the primary classification receiving device comprises a receiving platform, a camera sensing device and a mechanical arm, the mechanical arm is matched with the camera sensing device to classify garbage into the classification garbage channel, classify the garbage into wet garbage and non-fermented garbage except the wet garbage, and further classify the non-fermented garbage, and the classification garbage channel comprises a plurality of garbage channels, and each garbage channel respectively receives one type of garbage in the classified garbage; the primary treatment device comprises an automatic crushing device, a fermentation tank and an automatic compression device, the crushed wet garbage enters the fermentation tank, and the fermentation tank is communicated with a sewer; the automatic compression device respectively compacts or compacts the non-fermented garbage received by the classification garbage channels. The invention can effectively and rapidly process the household garbage and reduce the workload of garbage processing.”

For example, in China patent number 213557460 entitled “Efficient kitchen is cutter structure for refuse treatment” by Yang Minjie, published June 29, 2021, the inventor describes, “The utility model relates to a surplus refuse treatment technical field in kitchen, concretely relates to efficient cutter structure for kitchen refuse treatment, including the round bar, the screw rod has all been welded at the upper and lower both ends of round bar, the outer wall top of round bar is provided with the baffle, there is the one end of connecting rod on the outer wall top of round bar through bolt locking, the other end welding of connecting rod has the hammer, and the hammer is located the below of baffle, the top that round bar outer wall central point put is provided with the plectane, the outer wall outside of plectane is provided with first blade, the outside at both ends is provided with the second blade about the outer wall of plectane, the outer wall bottom of round bar is provided with the connecting plate, the outer wall of connecting plate is provided with first grindstone, the drum has been cup jointed to the outer wall bottom of round. The device can be effectual smash the operation to kitchen garbage, carries out breakage and grinding operation to bone, the high crude fiber food of intensity in the kitchen garbage, more accords with actual user demand.”

For example, in China patent number 106925396 entitled “A kind of food refuse disposer” by Deng Chunfang, published July 7, 2017, the inventor describes, “The invention discloses a kind of food refuse disposer, including grinding chamber, the grinding chamber is externally provided with blimp, the grinding chamber top is provided with mounting interface, the mounting interface is provided with 3 bayonet apparatus, the grinding chamber upper side wall is provided with dish-washing machine interface, grinding base is provided with the grinding chamber, the grinding base top is provided with cutterhead, the cutterhead be provided with four can 360 ° revolution impact heads, motor is provided with the grinding chamber, the motor is provided with motor bearings, the motor bearings is provided with rubber oil sea, the cutterhead is arranged on motor bearings, the grinding chamber middle part of sliding channel is provided with sewage draining exit, the processor built in air switch. The invention provides a kind of simple structure, easy to use, the stink that kitchen is especially deposited in the cabinet of dustbin can be reduced, reduce pollution of the rubbish from cooking to Recyclable, improve the food refuse disposer of resource recovery.”

For example, in Japan patent number 2,006,017,315 entitled “Dryer control system and its method” by Hiroaki Ueno, published January 19, 2006, the inventor describes, “… In a charging process for charging the dried objects 11 into a drying chamber 18, an agitating blade 32 is controlled to be rotationally driven at a preset constant target speed until load torque exceeds preset threshold torque PS. Then, when the load torque exceeds the threshold torque PS, a transition is made to a drying process for heating and drying the charged dried objects 11 being agitated. In the drying process, the driving toque of the agitating blade 32 is increased until reaching preset constant target torque T1 and then a constant torque control mode is executed for rotational drive to maintain the target torque. When load is reduced with the progress of a drying degree to establish the condition of drive with torque not higher than the target torque, a transition is made to a crushing process for crushing the dried objects into small dried pieces. In the crushing process, the agitating blade is controlled to be rotationally driven at a preset constant crushing speed.”

For example, in Japan patent number 2,011,025,124 entitled “Method for recycling unused food resource and device used for this method” by Hiroaki Ueno, published June 19, 2013, the inventor describes, “… To provide a recycling method which shows high recycling efficiency and low operating cost without sacrificing safety, nutritive ingredients and flavor, with regard to not only specified food residues but also various food materials, as well as a recycling method using this device. … This method for recycling unused food resources comprises the following processes: (1) A first process to sort out unused food resources and load the sorted ones into a first grinder, (2) a second process to input data such as the description and quantity of loaded unused food resources, then thereby set a drying mode according to ground grain size and by a heat dryer and set the grain size of a final finished product, (3) a third process to actuate the first grinder so that the loaded unused food resources come out to be as per the ground grain size set in the second process, (4) a fourth process to charge the grinds formed to the specified grain size into a drying chamber of the heat dryer, and a fifth process to set a heating temperature and a drying time of the heat dryer based on drying mode set in the second process and perform heat drying of the grinds charged in the drying chamber. Finally, the heat dried grinds are charged into a second grinder and further finely ground to the grain size, of the final finished product, set in the second process.”

For example, in China patent number 203729393 entitled “Food waste processor” by Hu Chenyang, published July 23, 2014, the inventor describes, “The utility model discloses a food waste processor which comprises a grinding gear ring, a cutter disc, a cutter head as well as an upper motor cover and a lower grinding chamber cover, wherein the cutter head is mounted on the cutter disc and is arranged inside the grinding gear ring; a plurality of grinding grooves are formed in the lower bottom side of the grinding gear ring; a plurality of saw teeth are arranged on the outer ring of the cutter disc; the grinding grooves are formed above the saw teeth; the upper motor cover and the lower grinding chamber cover are integrally manufactured. The food waste processor disclosed by the utility model has multiple grinding grades, and due to adoption of the more reasonable grinding structure, plant fibers can be effectively crushed, the size of the grinded plant fiber is not greater than 2 mm, and then a sewer is prevented from being blocked.”.

### SUMMARY OF THE INVENTION

A desiccator has a grinder. The grinder is configured to receive intake material. A grinder outlet tube connects the grinder to the desiccator assembly. A desiccator assembly is configured to desiccate the intake material. The grinder outlet tube is configured to transfer the intake material from the grinder to the desiccator chamber. An electronic controller controls the operation of the grinder and the desiccator assembly. The grinding blade is mounted above a grinding blade table. The grinding blade is mounted in a grinding chamber of the grinder. The grinding blade is configured to grind the intake material to a small enough size to pass through the grinder outlet tube. The desiccator assembly further includes a desiccator drum rotatably mounted on a drum axle bearing. A drum motor rotates the drum. The motor is controlled by the electronic controller.

The heater panel has a heater coil. The heater panel is curved and mounted below the desiccator drum. The drum motor chain transfers drum motor power to a drum axle. The drum motor is mounted below the desiccator drum. A sweeper has a sweeper brush that sweeps desiccated material into a bagger for bagging. The sweeper may have a blower fan. The exit funnel receives desiccated material from the desiccator drum. The exit funnel directs the desiccator material to a bagger. The bagger has a bag roll and has continuous operation to bag desiccated material as bagged material. The outlet tube is mounted in or to an outlet conduit.

### BRIEF DESCRIPTION OF THE DRAWINGS

FIG. 1 is a rear view of the grinder cabinet with the rear panel removed so as to provide a view similar to a rear section view.

FIG. 2 is a diagram showing the flow of intake material through the garbage disposer and into a bagged state.

FIG. 3 is a diagram showing the cabinet housing.

FIG. 4 is a big diagram showing the coil.

FIG. 5 is a side view of the desiccator drum showing the angled vanes.

The following call out list of elements can be a useful guide in referencing the element numbers of the drawings.

20 Grinder

21 Grinder Body Sidewall

22 Grinder Outlet Conduit

23 Grinder Motor Controller

24 Grinder Motor

25 Grinder Power Supply

26 Grinder Controller

27 Grinder Motor Frame Mount

28 Grinder Cabinet

29 Grinder Cabinet Sidewall

30 Desiccator Assembly

31 Desiccator Drum

32 Drum Motor

33 Drum Motor Axle

34 Drum Motor Chain

35 Drum Axle

36 Heater Panel

37 Heater Coil

38 Drum Axle Bearing

39 Drum Frame Mount

40 Intake Funnel

41 Grinder Chamber

42 Grinding Blade

43 Grinding Blade Table

44 Grinder Outlet Tube

45 Drum Axle Bearing Opening

46 Desiccator Chamber

47 Sweeper

48 Sweeper Head

49 Bagger

50 Intake Material

51 Grinded Material

52 Outlet Material

54 Slurry

56 Collected Desiccated Material

57 Bagged Material

58 Bag Roll

59 Bag Bin

60 Housing

61 Grinder Hatch

62 Electronic Control System

63 Vent

64 Display

65 Wheel

66 Access Hatch

67 Right Frame Endcap

68 Left Frame End Cap

69 Front Panel

70 Housing Top

71 First Electrical Conductor

72 Second Electrical Conductor

73 Coil Periphery

74 Coil Interior

75 Opening Area

76 Sweeper Assembly

77 First Tilt Wheel

78 Second Tilt Wheel

79 Heater Panel Mounting Area

80 Exit Funnel

81 First Scoop Vane

82 Second Scoop Vane

83 Third Scoop Vane

84 Fourth Scoop Vane

85 Fifth Scoop Vane

86 Sixth Scoop Vane

87 Seventh Scoop Vane

88 Eighth Scoop Vane

91 Drum Rear

92 Drum Front

93 Clockwise Rotation

94 Counterclockwise Rotation

95 Vane Angle

96 Inside Wall

97 Automatic Humidity Sensor

99 Electronic Controller

### DETAILED DESCRIPTION OF THE EMBODIMENTS

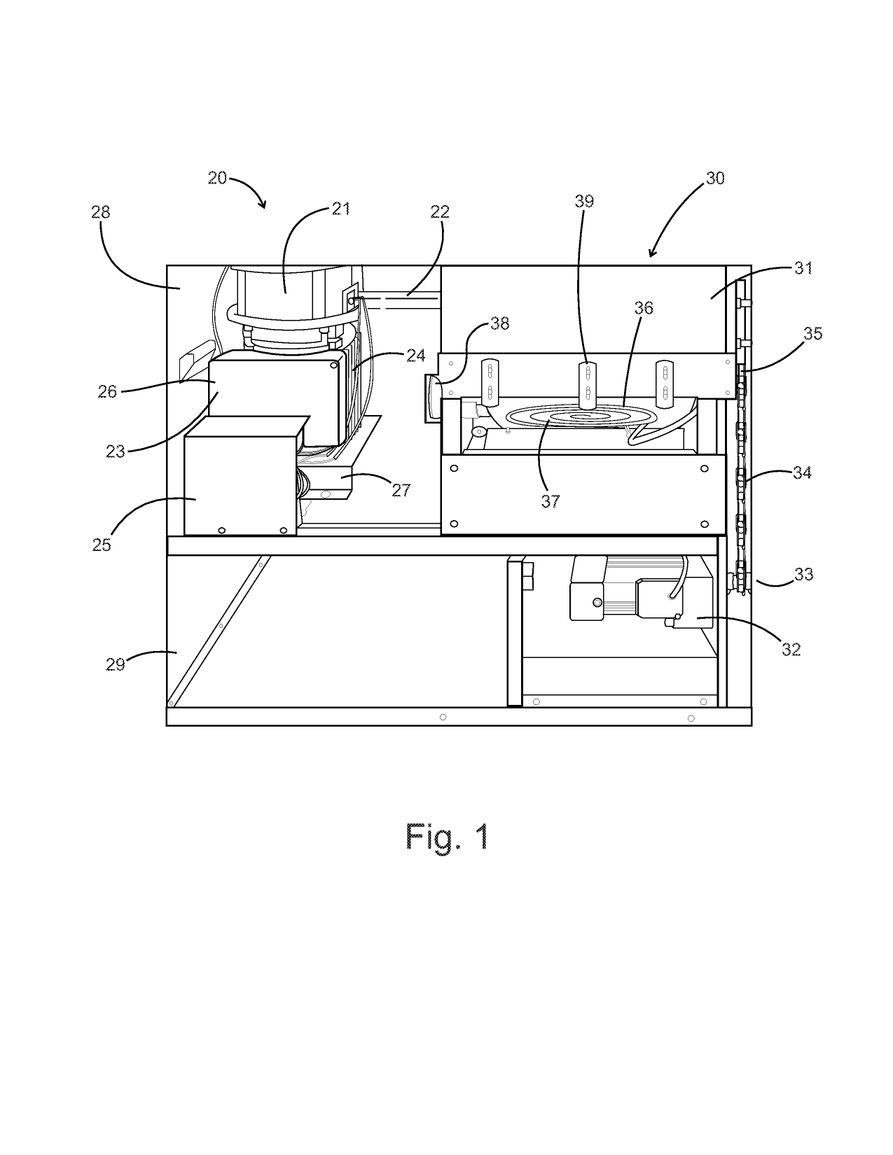

As seen in FIG. 1, the desiccator can be used as a garbage disposer apparatus with a grinder 20. The grinder 20 has a grinder body sidewall 21 which retains material within the sidewall. Ground material can exit through a grinder outlet conduit 22 after grinding. The grinder cabinet 28 retains the grinder motor 24 which can be mounted on a grinder motor frame mount 27. The grinder frame mount 27 attaches to the grinder cabinet 28 and the grinder motor 24.

The grinder motor 24 can be mounted with a grinder controller 26. The grinder controller 26 can electronically control the speed and torque of the grinder motor 24. Optionally, the grinder controller 26 can reverse the grinder motor 24 when the grinder motor 24 is a reversible motor. The grinder controller 26 can also be mounted to the grinder motor frame mount 27. The grinder power supply 25 powers the grinder motor 24. The grinder motor controller 23 is electrically connected to the grinder power supply 25. The grinder motor controller 23 can automatically stop the grinder motor 24 when the grinder Hatch is open for example. The grinder outlet conduit 22 is connected to the grinder body sidewall 21. The grinder cabinet sidewall 29 can be an exterior sidewall that the grinder motor frame mount 27 mounts to.

The desiccator assembly 30 is adjacent to the grinder 20. The desiccator drum 31 is mounted on a drum axle 35. The drum axle 35 is mounted to a drum axle bearing 38. The desiccator drum 31 is substantially hollow and receives material through the grinder outlet conduit 22. A heater panel 36 having a heater coil 37 can be mounted to the panel 36 can heat the heater drum 31 including the desiccator drum cavity as well as material in the desiccator drum. The heater panel 36 is preferably mounted directly under the desiccator drum 31. The heater panel 36 is preferably curved so that it matches the cylindrical shape of the desiccator drum 31. The desiccator drum 31 has a drum motor 32 driving it. The drum motor 32 drives a drum motor axle 33. The drum motor axle 33 drives a drum motor chain 34. The drum motor chain 34 drives the drum axle 35. The drum axle 35 is connected to the drum motor chain 34 such that the drum axle 35 rotates with the rotation of the drum motor 32. The drum motor 32 is mounted underneath the desiccator drum 31. The drum axle bearing 38 can be mounted to the drum frame mount 39.

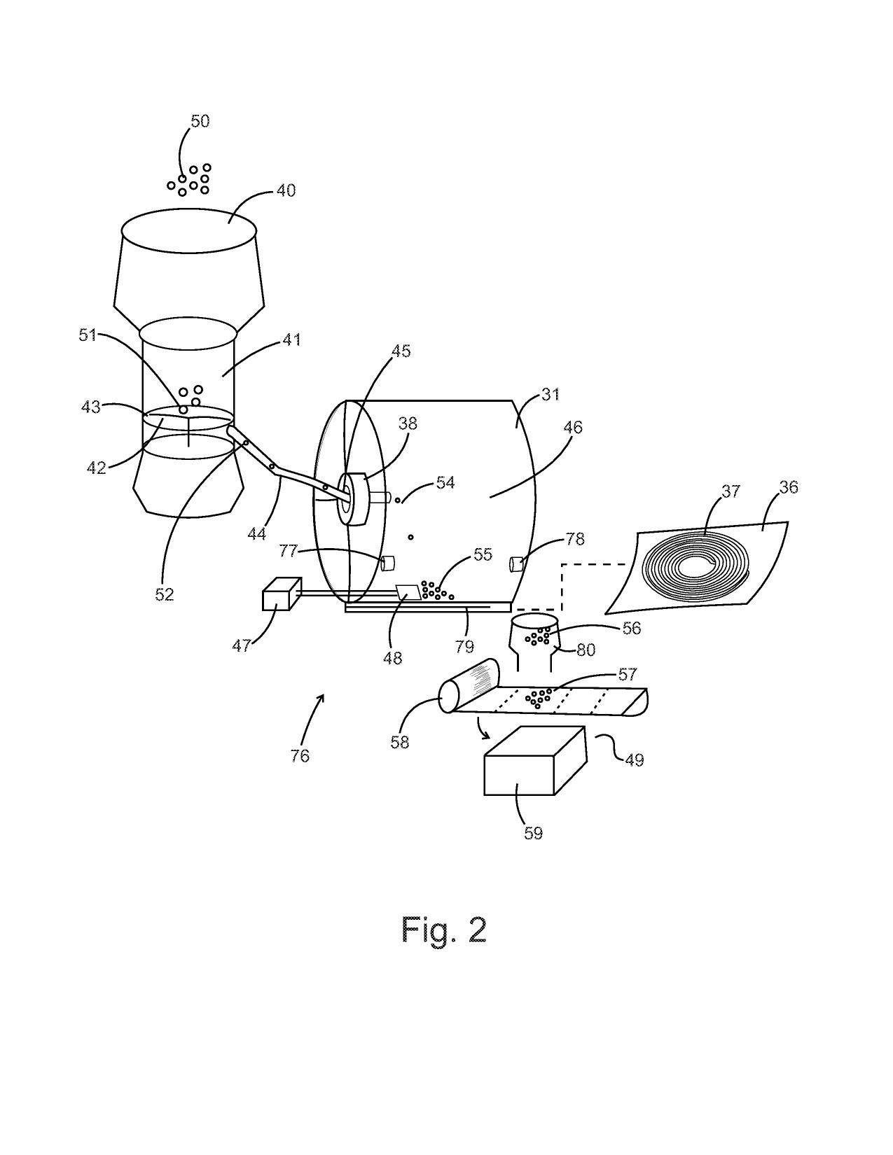

As seen in FIG. 2, the grinder intake funnel 40 receives intake material 50. The intake material 50 begins as food scraps which are then grind it into grinding material 51 in a grinding chamber 41. The grinding chamber 41 has a grinding blade 42 mounted on a grinding blade table 43. The printed material 51 on the grinding blade table 43 then becomes outlet material 52 which exits through the grinder outlet tube 44. The grinder outlet tube 44 can be mounted within or adjacent to the grinder outlet conduit 22.

The desiccator drum 31 has a desiccator chamber 46. When the outlet material 52 passes through the grinder outlet tube 44, it may exit as a slurry 54. The drum axle bearing may have a drum axle bearing opening 45 that the grinder outlet tube 44 passes through. The drum can be rotated on and supported by wheels such as a first tilt wheel 77 and a second tilt wheel 78.

After desiccation, the sweeper 47 may have a sweeper head 48 that sweeps desiccated material 55 out of the desiccator chamber 46. The sweeper assembly may include a sweeper 47 and a sweeper head 48 mounted on a sweeper boom. The sweeper boom can be formed as a rod that extends from the sweeper 47 to the sweeper head 48.

The heater panel 36 is preferably mounted at the heater panel mounting area 79. The heater panel mounting area 79. The heater panel is preferably curved, and the heater panel mounting area 79 is also curved to the shape of the drum. After desiccation, the contents can be removed using a tilt of the drum such as by moving a first tilt wheel 77 and a second tilt wheel 78, or by a sweeper assembly 76. A sweeper assembly 76 can include a sweeper 47 and a sweeper head 48.

The collected desiccated material 56 falls into a bag roll 58. The bag roll 58 passes over a bag bin 59. The bag bin 59 receives the collected desiccated material 56 at an exit funnel 80. When the desiccated material 55 passes through the exit funnel 80, the desiccated material 55 falls onto the bag and becomes bagged material 57. The bag bin 59 receives the bagged material 57 and provides a support for the bag roll 58. The bagger 49 automatically and continuously bags the collected desiccated material 56. A variety of different baggers can be used for automatically bagging the material. However, it is preferred to have a bag roll 58 supported at a bag bin 59 such that the bagged material 57 can be a continuous process.

The sweeper head 58 can be a wire brush or the like that automatically pushes out material from the desiccator chamber 46. The sweeper assembly 76 can also be a fan that blows out the desiccated material 55 into the exit funnel 80. The heater panel mounting area 79 is preferably curved and can be modular for allowing multiple heater panels 36 to be modularly attached and removed. The bearing 38 can have a drum axle bearing opening 45 which the grinder outlet tube 44 passes through. The grinder outlet tube 44 can also exit directly into the desiccator chamber 46. The sweeper assembly 76 may have both a fan and a brush.

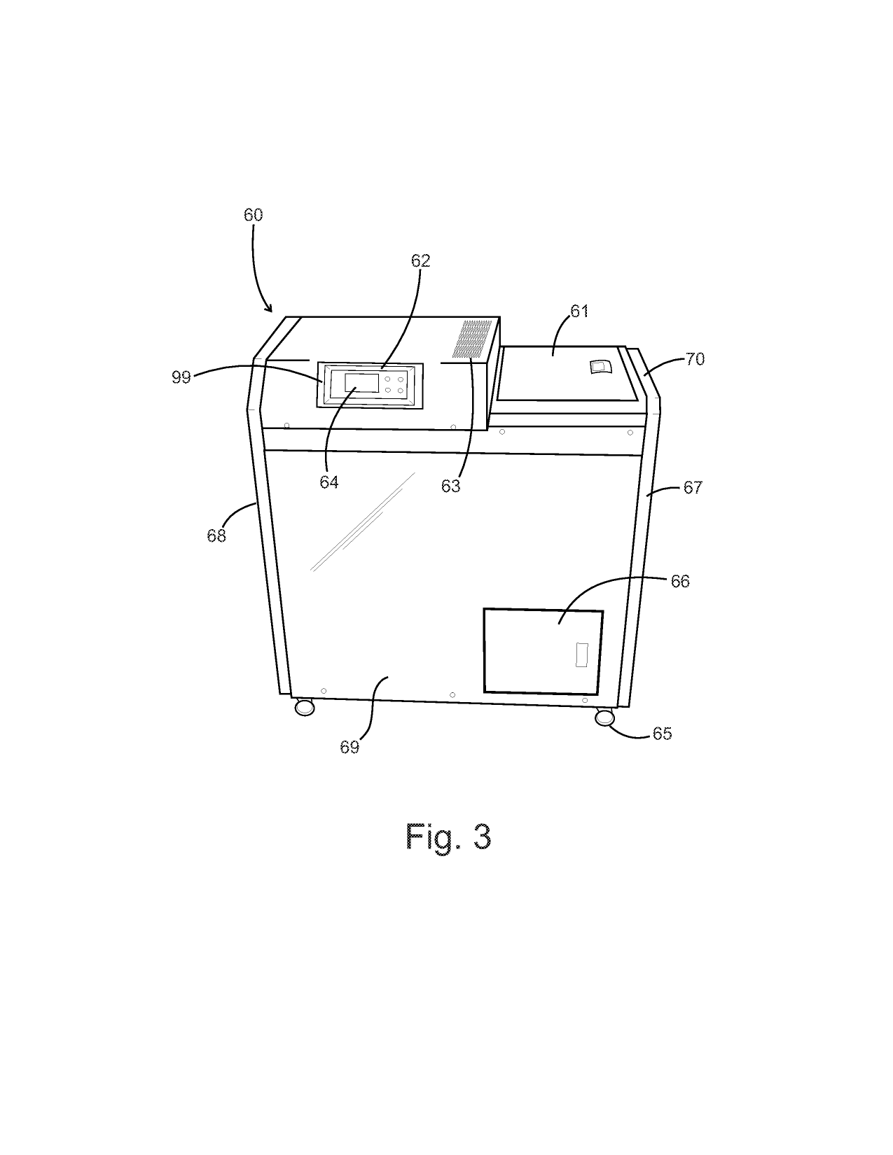

As seen in FIG. 3, the housing 60 has a grinder hatch 61. A user loads material into the grinder hatch 61. The grinder hatch is then closed. The grinder hatch preferably has a sensor that senses the closing of the hatch. The material loaded into the hatch is then subject to grinding. The grinder hatch 61 is preferably on the housing top 70.

The housing 60 also has an electronic control system 62 that only starts the grinder when the grinder hatch 61 is closed. The housing 60 may also preferably have a vent 63 on the housing top 70. Preferably, a display 64 shows the current operation of the machine and the display 64 is preferably controlled by the electronic control system 62. The electronic control system 62 also preferably controls the heating, motor control of the grinder and the motor control of the desiccator drum. The housing 60 preferably includes a right frame end cap 67 and a left frame end cap 68. The access hatch 66 can be open for retrieving desiccated material. The housing 60 is mounted on a set of wheels 65. The front panel 69 has a display 64.

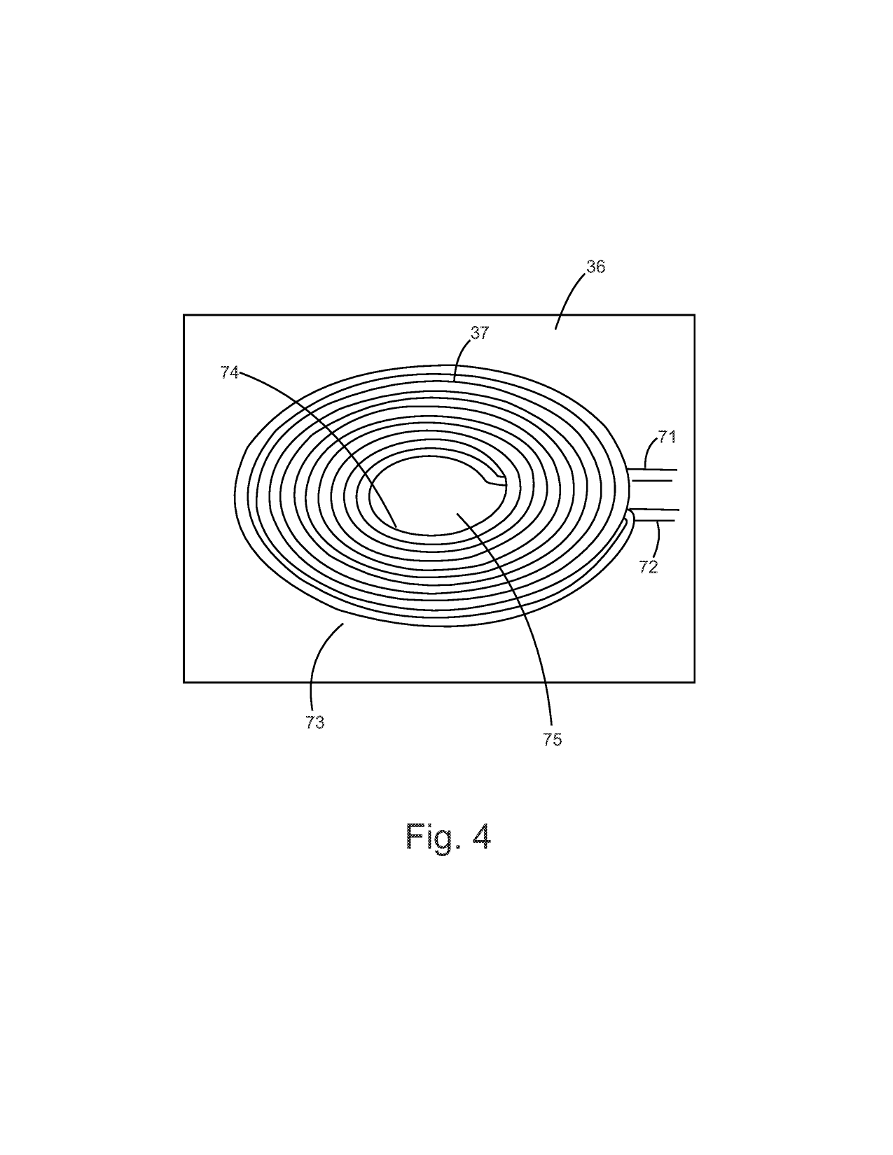

As seen in FIG. 4, the heating coil can have a coil interior 74 and a coil periphery 73. The coil interior 74 can be wound around an opening area 75. The first electrical conductor 71 and the second electrical conductor 72 can be mounted to connect to the power supply. The power supply can be regulated by the electronic control system 62.

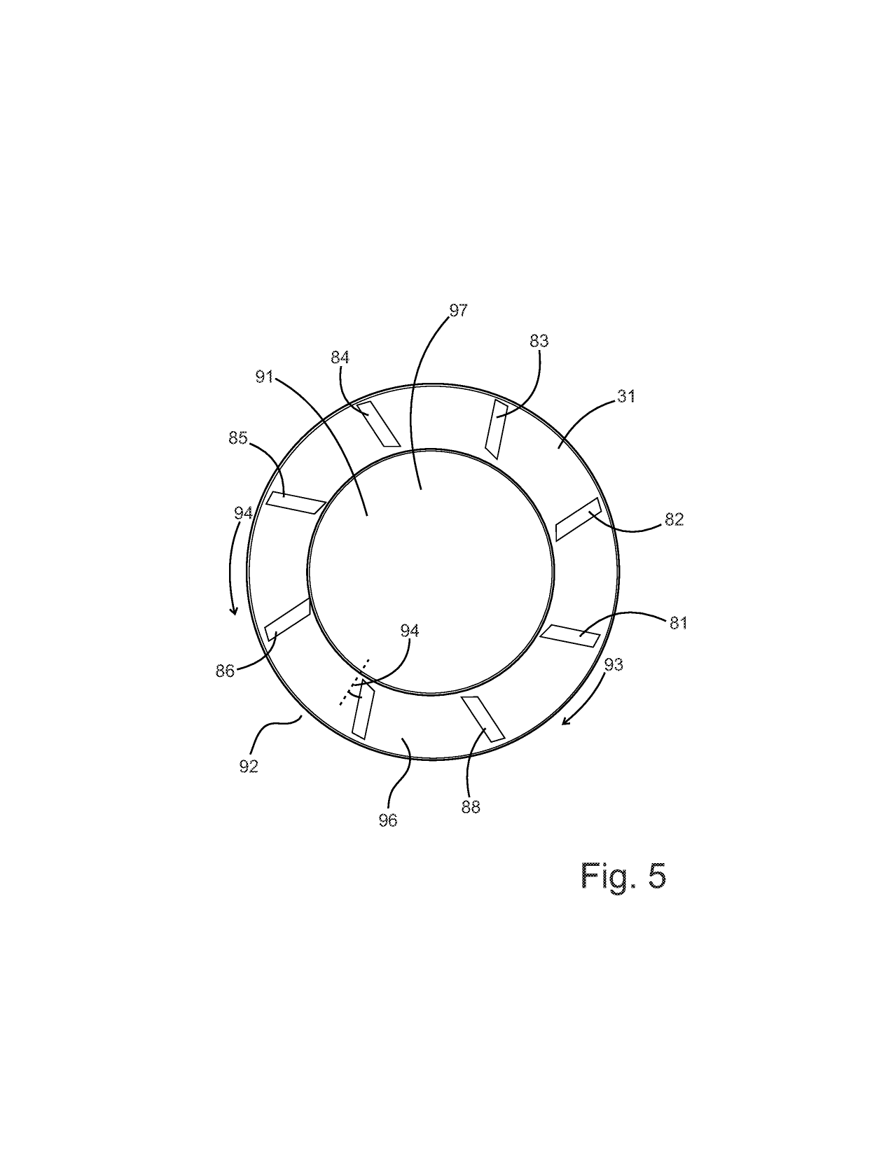

As seen in FIG. 5, the exit funnel has a desiccator drum 31 which has a drum rear 91 and a drum front 92. The desiccator drum has an inside wall 96 that is heated by the heater. The desiccator drum inside wall 96 and has scoops mounted to the inside wall that are formed as vanes which can move the material inward and outward in a screw like fashion. The first scoop vane 81, second scoop vane 82, third scoop vane 83, fourth scoop vane 84, fifth scoop vane 85, sixth scoop vane 86, seventh scoop vane 87, and eight scoop vane 88 can be bolted or welded to the inside wall 96 at an angle such as a vane angle 95. When the desiccator drum rotates in one direction, the material will collect toward the drum rear 91 and when the desiccator drum rotates in the other direction, the material will empty out of the drum front 92. An automatic humidity sensor can determine when the material is dry enough to be emptied out of the drum front 92. The automatic humidity sensor 97 provides a signal to the electronic controller 99 and the electronic controller 99 can control the grinder motor through the grinder controller 26 and the drum motor controller. The mode for emptying the contents in this diagram would be a clockwise rotation 93, and a counterclockwise rotation 94 would collect the contents while the contents are still drying out. After several uses, some material will collect on the inside wall 96 and the sweeper 47 with a sweeper head 48 can sweep out the dried on material.

1. A desiccator comprising:
a. a grinder, wherein the grinder is configured to receive intake material;
b. a grinder outlet tube connecting the grinder to the desiccator assembly;
c. a desiccator assembly, wherein the desiccator assembly is configured to desiccate the intake material, wherein the grinder outlet tube is configured to transfer the intake material from the grinder to the desiccator chamber; and
d. an electronic controller, wherein the electronic controller controls the operation of the grinder and the desiccator assembly.

2. The desiccator of claim 1, further comprising a grinding blade mounted above a grinding blade table, wherein the grinding blade is mounted in a grinding chamber of the grinder, wherein the grinding blade is configured to grind the intake material to a small enough size to pass through the grinder outlet tube.

3. The desiccator of claim 1, wherein the desiccator assembly further includes a desiccator drum, wherein the desiccator drum is rotatably mounted on a drum axle bearing, a drum motor, wherein the drum motor rotates the drum, wherein the motor is controlled by the electronic controller.

4. The desiccator of claim 3, further including a heater panel with a heater coil, wherein the heater panel is curved and mounted below the desiccator drum.

5. The desiccator of claim 3, further including a drum motor chain, wherein the drum motor chain transfers drum motor power to a drum axle, wherein the drum motor is mounted below the desiccator drum.

6. The desiccator of claim 1, further including a sweeper, wherein the sweeper brush sweeps the desiccated material into a bagger for bagging.

7. The desiccator of claim 1, wherein the sweeper further includes a blower fan.

8. The desiccator of claim 1, further including an exit funnel receiving desiccated material from the desiccator drum, wherein the exit funnel directs the desiccator material to a bagger.

9. The desiccator of claim 1, wherein the bagger has a bag roll and has continuous operation to bag desiccated material as bagged material.

10. The desiccator of claim 1, wherein the outlet tube is mounted in or to an outlet conduit.

11. A desiccator comprising:
a. a grinder, wherein the grinder is configured to receive intake material;
b. a grinder outlet tube connecting the grinder to the desiccator assembly;
c. a desiccator assembly, wherein the desiccator assembly is configured to desiccate the intake material, wherein the grinder outlet tube is configured to transfer the intake material from the grinder to the desiccator chamber;
d. an electronic controller, wherein the electronic controller controls the operation of the grinder and the desiccator assembly; wherein the desiccator assembly further includes a desiccator drum, wherein the desiccator drum is rotatably mounted on a drum axle bearing, a drum motor, wherein the drum motor rotates the drum, wherein the motor is controlled by the electronic controller;
e. a heater panel with a heater coil, wherein the heater panel is curved and mounted below the desiccator drum; and
f. a drum motor chain, wherein the drum motor chain transfers drum motor power to a drum axle, wherein the drum motor is mounted below the desiccator drum.

12. The desiccator of claim 11, further comprising a grinding blade mounted above a grinding blade table, wherein the grinding blade is mounted in a grinding chamber of the grinder, wherein the grinding blade is configured to grind the intake material to a small enough size to pass through the grinder outlet tube.

13. The desiccator of claim 11, further including a sweeper, wherein the sweeper brush is the desiccated material into a bagger for bagging.

14. The desiccator of claim 11, wherein the sweeper further includes a blower fan.

15. The desiccator of claim 11, further including an exit funnel receiving desiccated material from the desiccator drum, wherein the exit funnel directs the desiccator material to a bagger.

16. The desiccator of claim 11, wherein the bagger has a bag roll and has continuous operation to bag desiccated material as bagged material.

17. The desiccator of claim 11, further comprising a grinding blade mounted above a grinding blade table, wherein the grinding blade is mounted in a grinding chamber of the grinder, wherein the grinding blade is configured to grind the intake material to a small enough size to pass through the grinder outlet tube; and further including a sweeper, wherein the sweeper brush is the desiccated material into a bagger for bagging, wherein the sweeper further includes a blower fan, further including an exit funnel receiving desiccated material from the desiccator drum, wherein the exit funnel directs the desiccator material to a bagger, wherein the bagger has a bag roll and has continuous operation to bag desiccated material as bagged material.
